(19) United States
(12) Patent Application Publication
(10) Pub. No.: US 2011/0135560 A1
(43) Pub. Date: Jun. 9, 2011

(54) USE OF A WEAKLY IONIC ACRYLIC POLYMER IN THE SYNTHESIS OF PRECIPITATED CALCIUM CARBONATE

(75) Inventors: Murielle Guillot, Caluire et Cuire (FR); Yves Kensicher, Theize (FR)

(73) Assignee: COATEX S.A.S., GENAY (FR)

(21) Appl. No.: 13/058,476

(22) PCT Filed: Aug. 4, 2009
(86) PCT No.: PCT/IB09/06530

§ 371 Date: Feb. 10, 2011

(30) Foreign Application Priority Data
Aug. 13, 2008 (FR) 08 04589

(51) Int. Cl. C01F 11/18

(52) U.S. Cl. 423/432; 423/430

(57) ABSTRACT

The invention consists in the use, in a method to manufacture a mineral matter, notably a precipitated calcium carbonate, of a polymer consisting of at least one vinylic monomer chosen from among acrylic or methacrylic acid, acrylamide, methacrylamide or a cationic monomer, or their blends, and at least one non-ionic monomer. The use of this polymer enables the carbonation time of the PCC to be reduced, without however impairing its crystallographic structure and its granulometric characteristics.

Synthetic or precipitated calcium carbonate (PCC) is a synthetic mineral matter used notably in paper, and more specifically in the mass filler or as a coating pigment. At the industrial scale it is obtained from quicklime (CaO) which is hydrated to form an aqueous suspension of calcium hydroxide (Ca(OH)₂). This reaction, which is called slaking of the quicklime, is followed by a carbonation step, during which the calcium hydroxide is made to react with the carbon dioxide introduced by bubbling into the reactive medium: precipitated calcium carbonate is then formed.

There are currently very many patents disclosing particular variants and characteristics of the method described above. It is easily understood that the kinetics of the PCC synthesis reaction, when calcium hydroxide is brought into contact with carbon dioxide, plays a decisive role for the production capacity of a PCC plant: the more rapid this reaction, the better will be the yield of the manufacturing plant in question. The skilled man in the art speaks of carbonation time, or of the time required completely to transform the slaked lime into calcium carbonate. Reducing this time is therefore an important economic challenge.

Many studies have addressed this problem from the point of view of the method. As an example, document WO 01 07365 proposes a method for manufacture of PCC with a reduced carbonation time, by means of a pressure lower than atmospheric pressure within the reactor where the carbonation reaction occurs. However, this type of solution implies modifications, which are generally costly, of the various production facilities.

The skilled man in the art has therefore turned to chemical solutions, based on the use of various additives within the PCC manufacturing method. In the document “Change of formation yield and characterization of PCC particle synthesized with impurity ions contents by carbonation process” (Materials Science Forum, 510-511, March 2006, pp. 1026-1029), it appears that the addition of certain ions (of aluminium, iron and magnesium) enables the kinetics of the carbonation reaction to be accelerated. This document also demonstrates that a modification of the crystallographic structure of the PCC formed is then observed, relative to the same method not using such ions.

In the document “Morphological characteristics and aggregation of calcite crystals obtained by bubbling CO₂ through Ca(OH)₂ suspension in the presence of additives” (Powder Technology, 130, 2003, pp. 307-315), it appears that the addition of citric acid, sucrose or sodium dodecyl sulphate substantially increases the carbonation time. Conversely, the use of a polyethylene glycol (of molecular weight equal to 300 g/mole) enables this time to be reduced; but in this case the surface specific area of the synthesised PCC is almost doubled.

With regard to the use of polyacrylates (chemical species well-known as being dispersants of PCC), their function differs depending on the envisaged method. The document “Precipitation of calcium carbonate in aqueous systems” (Tenside Surfactants Detergents, volume 36, 1999, pp. 162-167) reveals that polyacrylic acid necessarily leads to the formation of vaterite, starting with a supersaturated calcium carbonate solution. It teaches nothing concerning the carbonation time. The document “Effect of macromolecules on the crystallization of CaCO₃” (Supramolecular Science, volume 5, n^{o} 3-4, 1988, pp. 3-4) demonstrates that this same acid inhibits the formation of crystals of PCC, in the case of a supersaturated calcium bicarbonate solution.

Finally, documents WO 2005/000742 and WO 2004/106236 disclose a method of manufacture of PCC, in which are introduced respectively a polyacrylate and a polyphosphate in the course of the carbonation reaction, before the latter is complete. Without providing any information concerning the influence of these additives on the carbonation time, these documents clearly demonstrate that the crystallographic structure of the PCC formed in this manner is not necessarily preserved in comparison with the PCC obtained without the use of these additives.

Consequently, the initial challenge of reducing the carbonation time is significant only if it is directly related to the following requirements:
identifying a chemical additive resolving this problem, which prevents the skilled man in the art from having to accomplish modifications which are sometimes complex and often costly to his production installation,
since the consequence of the addition of the said additive must not be to modify the crystallographic structure of the manufactured PCC, nor to impair its granulometric characteristics, with the understanding that the skilled man in the art wishes to improve his production capacity whilst at the end of the process having a product with unchanged characteristics,
the addition of the said additive must lead to an aqueous suspension having a maximum dry weight content of PCC, since this requirement is related to the economic advantage of manufacturing a suspension with as high as possible a concentration of active material.

With a view to resolving this complex technical problem, the Applicant has developed the use, in a method for the manufacture of precipitated calcium carbonate (PCC), as an agent to reduce the carbonation time of the said carbonate, of at least one copolymer characterised in that it is constituted, expressed as a molar percentage of each of its monomers:
a) 10% to 99%, preferentially 50% to 98%, very preferentially 80% to 97%, and extremely preferentially 85% to 95% of at least one vinylic monomer other than the monomer of formula (I),
b) 1% to 90%, preferentially 2% to 50%, very preferentially 3% to 20%, and extremely preferentially 5% to 15% of at least one non-ionic monomer, of formula (I):

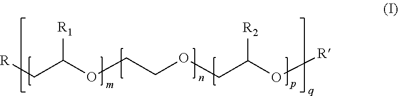

where:
m, n, p and q are integers and m, n, p are less than 150 and at least one of them is greater than 0, preferentially 20,
R contains one polymerisable unsaturated group,
R₁ and R₂ are identical or different and represent hydrogen atoms or alkyl groupings having 1 to 4 carbon atoms,
R′ represents hydrogen or a hydrocarbonated radical with 1 to 40 carbon atoms,
preferentially 1 to 4 carbon atoms, where R′ is very preferentially the methyl radical, or a blend of several monomers of formula (I),
   where the sum of the molar percentages of monomers a) and b) is equal to 100%.

In a completely surprising and advantageous manner, the use of such a polymer, notably before and/or in the course of the step of bringing the aqueous suspension of slaked lime in contact with the carbon dioxide, allows the carbonation time to be reduced. In addition, this goal is reached without however modifying the crystallographic structure of the PCC: the latter is identical to that obtained without using the said copolymer. Moreover, the granulometric characteristics (median diameter and surface specific area) of the PCC are not impaired. Finally, an aqueous suspension of PCC is successfully made with a completely acceptable maximum dry extract and viscosity, without the use of added water with a view to correcting a viscosimetric drift.

Without wishing to be bound by any particular theory, the Applicant is of the opinion that these results, and above all the possibility of reducing the carbonation time, are explained by the capacity of the said copolymer efficiently to disperse the particles of slaked lime in the water, which improves their reactivity with the carbon dioxide. In addition, this dispersing power also applies to the PCC, once the carbonation reaction is terminated: an aqueous suspension of PCC is obtained which has a completely acceptable viscosity (from the point of view of its workability and transport), without having to add water to cause a reduction of viscosity.

In the context of the invention, the Applicant believes that the dispersal phenomenon is probably governed by a steric repulsion mechanism, due to the weakly ionic character of the copolymer used: it is not an ionic mechanism in which the dispersant is absorbed at the surface of the mineral particles, as in the case of a standard polyacrylate. As a consequence, the said copolymer, unlike a polyacrylate, does not act as a crystallisation inhibitor: this would explain why the crystallographic structure of the PCC formed is retained, i.e. why it remains identical to the one obtained by the same method, but without the copolymer of the invention.

Thus, a first object of the invention consists in the use, in a method to manufacture a precipitated mineral material, of at least one copolymer characterised in that it consists, expressed as a molar percentage of each of its monomers:
a) 10% to 99%, preferentially 50% to 98%, very preferentially 80% to 97%, and extremely preferentially 85% to 95% of at least one vinylic monomer other than the monomer of formula (I),
b) 1% to 90%, preferentially 2% to 50%, very preferentially 3% to 20%, and extremely preferentially 5% to 15% of at least one non-ionic monomer, of formula (I):

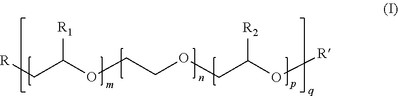

where:
m, n, p and q are integers and m, n, p are less than 150 and at least one of them is greater than 0, preferentially 20,
R has at least one polymerisable unsaturated group,
R₁ and R₂ are identical or different and represent hydrogen atoms or alkyl groupings having 1 to 4 carbon atoms,
R′ represents hydrogen or a hydrocarbonated radical with 1 to 40 carbon atoms,
preferentially 1 to 4 carbon atoms, where R′ is very preferentially the methyl radical, or a blend of several monomers of formula (I),
   where the sum of the molar percentages of monomers a) and b) is equal to 100%.

This use is also characterised in that the precipitated mineral material is a precipitated calcium carbonate.

This use is also characterised in that the vinylic monomer other than the monomer of formula (I) is chosen from among acrylic or methacrylic acid, acrylamide, methacrylamide or a cationic monomer, or their blends.

This use is also characterised in that the cationic monomer is chosen from among the (meth)acrylic esters of cationic monomers, and preferentially of [2-(methacryloyloxy)ethyl]trimethyl ammonium chloride or sulphate, of [2-(acryloyloxy)ethyl]trimethyl ammonium chloride or sulphate, of [3-(acrylamido)propyl]trimethyl ammonium chloride or sulphate, of dimethyl diallyl ammonium chloride or sulphate, or of [3-(methacrylamido)propyl]trimethyl ammonium chloride or sulphate, or their blends.

This use is also characterised in that the polymerisable group is chosen from among the vinylic groups, or the acrylic, methacrylic or maleic ester groups, or the urethane unsaturated groups, and is preferably an acrylurethane, methacrylurethane, α-α′ dimethyl-isopropenyl-benzylurethane or allylurethane group, or the allylic or vinylic ether groups, whether or not substituted, or the ethylenically unsaturated amide or imide groups, and is preferentially the methacrylic ester group.

This use is also characterised in that the said copolymer is obtained in the acidic form and possibly distilled, and is partially or totally neutralised by one or more neutralisation agents having a monovalent or polyvalent cation, where the said agents are chosen preferentially from among ammonia or from among calcium, sodium, magnesium, potassium or lithium hydroxides and/or oxides, or from among the aliphatic and/or cyclic primary, secondary or tertiary amines, and preferentially from among stearylamine, the ethanolamines (mono-, di- and triethanolamine), mono- and diethylamine, cyclohexylamine, methylcyclohexylamine, amino methyl propanol, morpholine, and preferentially in that the neutralisation agent is sodium hydroxide.

This use is also characterised in that the said copolymer is obtained by methods of radical polymerisation in solution, in a direct or reverse emulsion, in suspension or precipitation in solvents, in the presence of catalytic systems and chain transfer agents, or again by methods of controlled radical polymerisation, and preferentially by nitroxide mediated polymerisation (NMP) or by cobaloximes, by atom transfer radical polymerisation (ATRP), by controlled radical polymerisation by sulphurated derivatives, chosen from among carbamates, dithioesters or trithiocarbonates (RAFT) or xanthates.

This use is also characterised in that the said copolymer may be, before or after the total or partial neutralisation reaction, treated and separated into several phases, using static or dynamic methods, by one or more polar solvents belonging preferentially to the group constituted by water, methanol, ethanol, propanol, isopropanol, the butanols, acetone, tetrahydrofuran or their blends.

This use of the said copolymer in a method of manufacture of a precipitated mineral matter, when the said precipitated mineral matter is a precipitated calcium carbonate, is also characterised in that the said method includes at least one step of supply of quicklime, at least one step of slaking of the said quicklime, and at least one step of carbonation of the said quicklime.

This use of the said copolymer in a method of manufacture of a precipitated mineral matter, when the said precipitated mineral matter is a precipitated calcium carbonate, is also characterised in that the said method consists in:
a) taking a quicklime powder;
b) either slaking the quicklime from step a) in 2 phases by:
partial slaking of the said quicklime by blending it with an aqueous solution b1) with a view to obtaining a partially hydrated lime,
followed by complete slaking through the addition to the said hydrated lime of an aqueous solution b2) with a view to obtaining a suspension of slaked lime;
b′) or slaking the quicklime from step a) in 1 phase by:
   blending with the aqueous solution b3) with a view to obtaining a suspension of slaked lime;
c) possibly grinding the suspension of slaked lime from step b) or b′),
d) causing the carbonation of the suspension of the slaked lime from step b) or b′) or c) through the introduction of CO2 in the said suspension of slaked lime;
   where the said polymer is introduced:
during step b) in the aqueous solution b1) and/or b2),
or during step b′) in the aqueous solution b3),
and/or during step c) in the reactive medium.

This use of the said copolymer in a method of manufacture of a precipitated mineral matter, when the said precipitated mineral matter is a precipitated calcium carbonate, is also characterised in that the said copolymer is used at a rate of 0.01 to 1% by dry weight, compared to the dry weight of slaked lime.

This use of the said copolymer in a method of manufacture of a precipitated mineral matter, when the said precipitated mineral matter is a precipitated calcium carbonate, is finally characterised in that the said copolymer is used as an agent allowing the carbonation time of the precipitated calcium carbonate to be reduced.

### EXAMPLES

### Example 1

In the following tests, precipitated calcium carbonate (PCC) is produced by bubbling CO₂ into an aqueous suspension of (Ca(OH)₂).

The polymers used are, in the case of the prior art, a sodium polyacrylate of molecular weight by mass equal to 10,500 g/mol (referenced PAA in the remainder of the Application) and a polyethylene glycol of molecular weight by mass equal to 600 g/mol (referenced PEG in the remainder of the Application).

The polymer used in the context of the invention (referenced P in the remainder of the Application) is a copolymer consisting of, by mole:
a) 79.8% of methacrylic acid and 9.0% of ethyl acrylate,
b) 11.2% of a monomer of formula (I), in which:
   R designates the methacrylate group,
   R′ designates the methyl group,
   m=p=0; n=45; q=1.

The efficiency or yield of the method of manufacture of the PCC is determined as being equal to the mass of PCC produced (in kg) compared to the mass of the suspension of PCC obtained (in kg) and to the carbonation time (in min).

The polymorphs of the PCC formed were characterised visibly using the images of the said polymorphs produced using Sweeping Electron Microscopy.

The median diameter d₅₀ (μm), where dₓ represents the value of the diameter for which x % by weight of particles have a diameter less than dₓ, of the PCC obtained was determined using a Sedigraph™ 5100 device sold by the company MICROMERITICS™.

The surface specific area, noted SSA (m²/g), of the particles of PCC obtained was determined using the BET method, in accordance with ISO standard 9277:1995.

The Brookfeld™ viscosity of the final suspension of PCC obtained was measured at 25° C., and at 100 revolutions/minute, and is noted μ100 (mPa·s).

The residual quantity of lime obtained in the final PCC was determined by X-ray Diffraction.

Test n^{o} 1: Reference Test, without Polymer, for Synthesis of a PCC of Calcite of Scalenohedron Shape.

200 kg of calcium oxide (origin: Austria) is introduced into a reactor while stirring, containing 1,700 litres of tap water at 40° C.; the medium is stirred for 30 minutes. The resulting suspension is then diluted with water, with a view to obtaining a given dry extract (or percentage by dry weight of mineral matter compared to the total weight of the said suspension, noted ES).

1,750 litres of this suspension is then raised to a temperature of 50° C. and introduced into a stainless steel cylindrical reactor of 1,850 litres, fitted with an agitator and with probes for measuring the pH and the conductivity of the medium.

From the bottom of the reactor, a gaseous mixture of air and CO₂ (containing between 20 and 30% by volume of CO₂) is bubbled in, at a flow rate of 200 m³/h, at the same time as the suspension is stirred at a speed of between 200 and 300 revolutions/minute. The boosting in terms of the supply gas is between 150 and 200 mbar, matching the hydrostatic pressure of Ca(OH)₂ within the reactor.

In the course of the carbonation the temperature of the suspension is not regulated, and may increase, under the effect of the heat generated during this exothermic reaction.

When the conductivity has reached its minimum value the bubbling is continued for another 4 minutes.

Test n^{o} 2: A Test Illustrating the Prior Art, Through the Synthesis of a PCC of Calcite of Scalenohedron Shape, in the Presence of the Polymer PAA

This test was undertaken according to the protocol described in test n^{o} 1, with introduction of 0.1% by dry weight of the polymer PAA (compared to the dry weight of Ca(OH)₂) into the suspension of Ca(OH)₂, before the carbonation step.

Test n^{o} 3: A Test Illustrating the Invention, Through the Synthesis of a PCC of Calcite of Scalenohedron Shape, in the Presence of the Polymer P

This test was undertaken according to the protocol described in test n^{o} 1, with introduction of 0.075% by dry weight of the polymer P (compared to the dry weight of Ca(OH)₂) into the suspension of Ca(OH)₂, before the carbonation step.

In each of the tests n^{o} 1 to 3, the final product has a mass content of residual lime of less than 6% of the total weight of the PCC obtained.

In these tests the carbonation times, representing the time elapsed between the moment of introduction of the gas and the moment when the conductivity exceeds its minimum threshold, and also the other measured parameters and magnitudes, are indicated in table 1.

Test n^{o} 4: Reference Test, Without Polymer, for the Synthesis of an Aragonitic PCC.

160 kg of calcium oxide (origin: United States) is introduced into a reactor while stirring, containing 1,300 litres of tap water at 50° C.; the medium is stirred for 30 minutes. The resulting suspension is then diluted with water, with a view to obtaining a given dry extract (or % by dry weight of mineral matter compared to the total weight of the said suspension, noted ES).

1,250 litres of this suspension is then raised to a temperature of 60° C. and introduced into a stainless steel cylindrical reactor of 1,850 litres, fitted with an agitator and with probes for measuring the pH and the conductivity of the medium.

Before the carbonation step clusters of PCC of the aragonitic type are introduced into the reactor.

From the bottom of the reactor, a gaseous mixture of air and CO₂ (containing between 4 and 8% by volume of CO₂) is first bubbled in, at a flow rate of 100 m³/h, at the same time as the suspension is stirred at a speed of between 200 and 300 revolutions/minute. The fraction of CO₂ in the blend is gradually increased up to a value of between 20 and 30% of the volume of the said blend. The elimination concerning the supply gas is then between 100 and 200 mbar, matching the hydrostatic pressure of Ca(OH)₂ within the reactor.

When the CO₂ content in the exhaust gas exceeds 6% by volume hot water is added to dilute the suspension, so as to obtain a certain viscosity (as indicated in table 1).

In the course of the carbonation the temperature of the suspension is not regulated, and may increase, under the effect of the heat generated during this exothermic reaction. When the conductivity has reached its minimum value the bubbling is continued for another 4 minutes.

Test n^{o} 5: A Test Illustrating the Invention, Through the Synthesis of a Aragonite PCC in the Presence of the Polymer P

This test was undertaken under the same conditions as test n^{o} 4, but with the use of 0.075% by dry weight (compared to the dry weight of Ca(OH)₂) of the polymer P, which was added into the slaking water, prior to the introduction of CaO into the reactor.

Test n^{o} 6: A Test Illustrating the Invention, Through the Synthesis of a Aragonite PCC in the Presence of the Polymer P

This test was undertaken under the same conditions as test n^{o} 4, but with the use of 0.075% by dry weight (compared to the dry weight of Ca(OH)₂) of the polymer P, which was added into the suspension, before the carbonation step.

Test n^{o} 7: A Test Illustrating the Invention, Through the Synthesis of a Aragonite PCC in the Presence of the Polymer P

This test was undertaken under the same conditions as test n^{o} 4, but with the use of 0.15% by dry weight (compared to the dry weight of Ca(OH)₂) of the polymer P, which was added into the suspension, before the carbonation step.

Test n^{o} 8: A Test Illustrating the Invention, Through the Synthesis of a Aragonite PCC in the Presence of the Polymer P

This test was undertaken under the same conditions as test no 4, but with the use of 0.20% by dry weight (compared to the dry weight of Ca(OH)₂) of the polymer P, which was added into the suspension, before the carbonation step.

In each of the tests n^{o} 4 to 8, the final product has a mass content of residual lime of less than 6% of the total weight of the PCC obtained.

In these tests the carbonation times, representing the time elapsed between the moment of introduction of the gas and the moment when the conductivity exceeds its minimum threshold, and also the other measured parameters and magnitudes, are indicated in table 1.

Test n^{o} 9: Reference Test, Without Polymer, for the Synthesis of an Aragonite PCC.

160 kg of calcium oxide (origin: Austria) is introduced into a reactor while stirring, containing 1,300 litres of tap water at 50° C.; the medium is stirred for 30 minutes. The resulting suspension is then diluted with water, with a view to obtaining a given dry extract (or percentage by dry weight of mineral matter compared to the total weight of the said suspension, noted ES).

1,250 litres of this suspension is then raised to a temperature of 60° C. and introduced into a stainless steel cylindrical reactor of 1,850 litres, fitted with an agitator and with probes for measuring the pH and the conductivity of the suspension.

Before the carbonation step clusters of PCC of the aragonite type are introduced into the reactor.

From the bottom of the reactor, a gaseous mixture of air and CO₂ (containing between 4 and 8% by volume of CO₂) is first bubbled in, at a flow rate of 100 m³/h, at the same time as the suspension is stirred at a speed of between 200 and 300 revolutions/minute. The fraction of CO₂ in the blend is gradually increased up to a value of between 20 and 30% of the volume of the said blend. The elimination concerning the supply gas is then between 100 and 200 mbar, matching the hydrostatic pressure of Ca(OH)₂ within the reactor.

When the CO₂ content in the exhaust gas exceeds 6% by volume hot water is added to dilute the suspension, so as to obtain a certain viscosity (as indicated in table 1).

In the course of the carbonation the temperature of the suspension is not regulated, and may increase, under the effect of the heat generated during this exothermic reaction. When the conductivity has reached its minimum value the bubbling is continued for another 4 minutes.

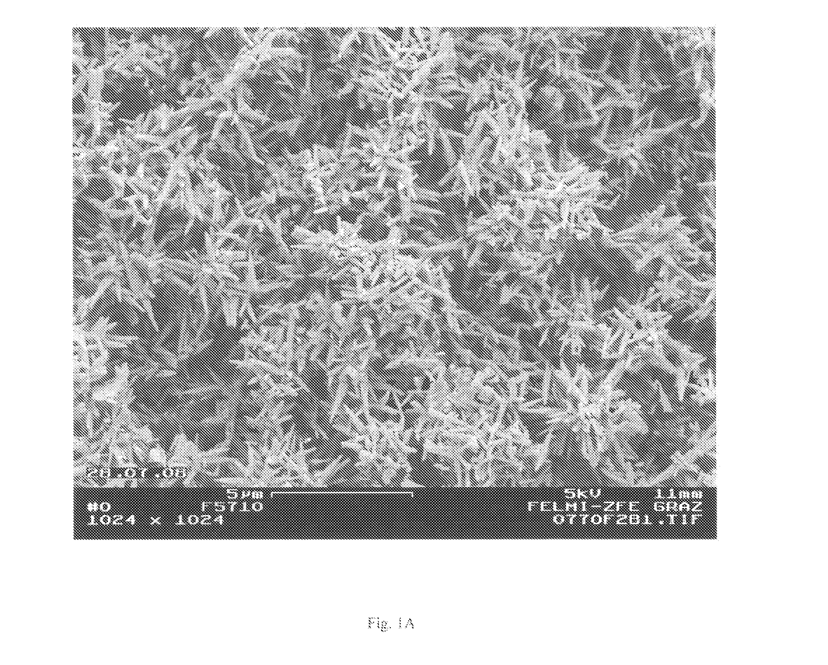

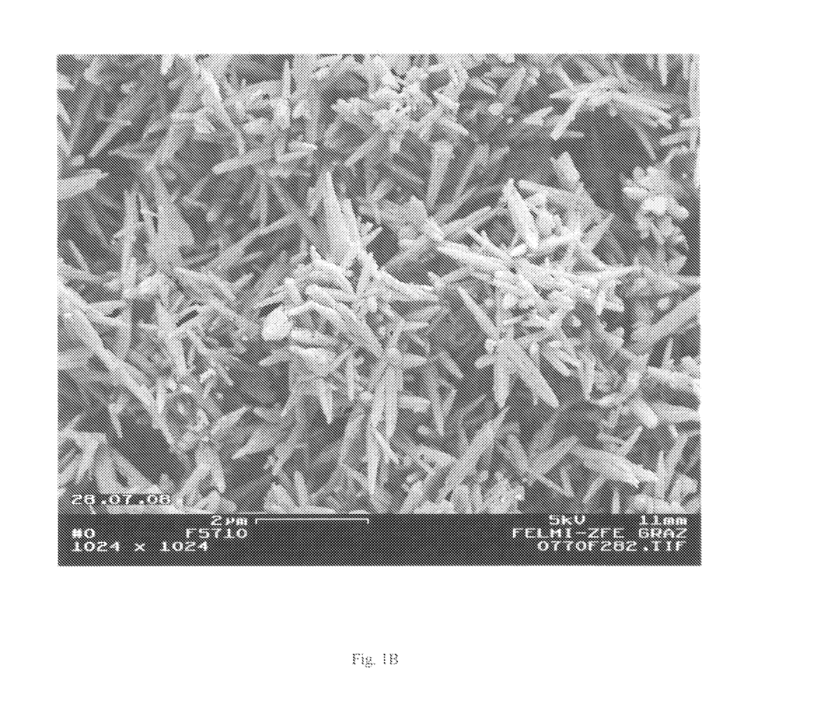

FIGS. 1A and 1B (enlargement of FIG. 1A) represent the image obtained using the Sweeping Electron Microscope of the polymorphs obtained, which have a needle shape, characteristic of a PCC of aragonite type.

Test n^{o} 10: A Test Illustrating the Invention, Through the Synthesis of a Aragonite PCC in the Presence of the Polymer P

This test was undertaken under the same conditions as test n^{o} 9, but with the use of 0.10% by dry weight (compared to the dry weight of Ca(OH)₂) of the polymer P, which was added into the suspension, before the carbonation step.

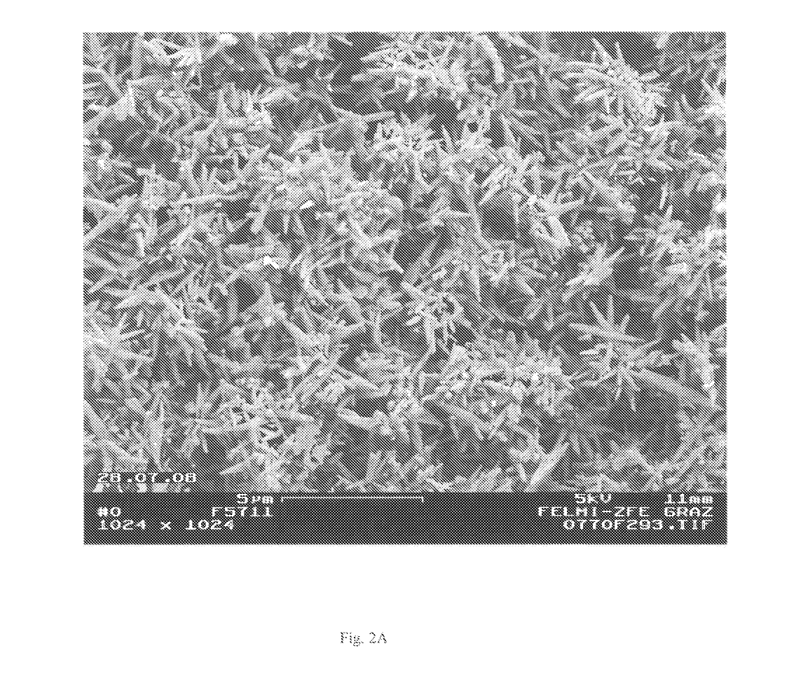

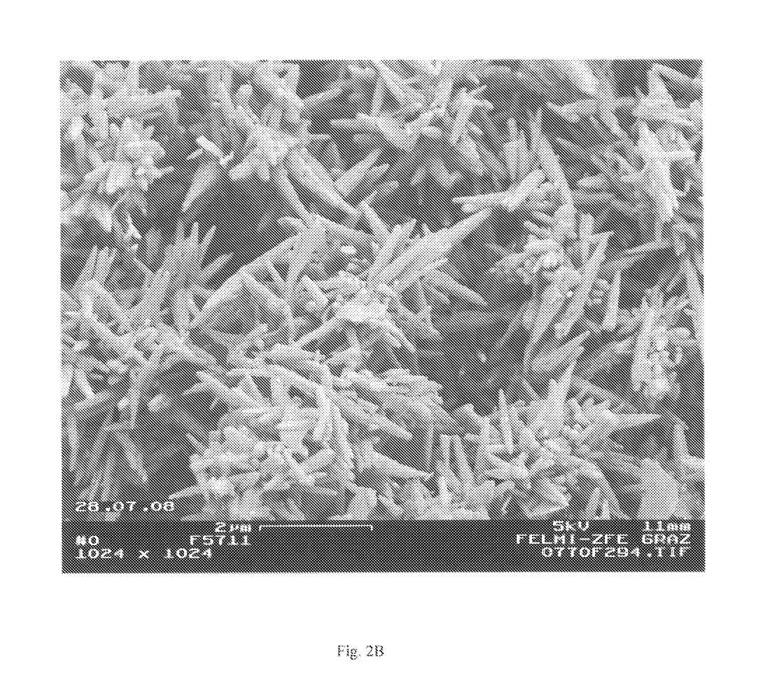

FIGS. 2A and 2B (enlargement of FIG. 2A) represent the image obtained using the Sweeping Electron Microscope of the polymorphs obtained, which have a needle shape, characteristic of a PCC of aragonite type.

Test n^{o} 11: A Test Illustrating the Prior Art, Through the Synthesis of a Aragonite PCC in the Presence of the Polymer PEG

This test was undertaken under the same conditions as test n^{o} 9, but with the use of 0.10% by dry weight (compared to the dry weight of Ca(OH)₂) of the polymer PEG, which was added into the suspension, before the carbonation step.

In each of the tests n^{o} 9 to 11, the final product has a mass content of residual lime of less than 6% of the total weight of the PCC obtained.

In these tests the carbonation times, representing the time elapsed between the moment of introduction of the gas and the moment when the conductivity exceeds its minimum threshold, and also the other measured parameters and magnitudes, are indicated in table 1.

TABLE 1

| | | % by | % by dry | | | | |
|---|---|---|---|---|---|---|---|
| | | weight of | weight of | | | | |
| | | the polymer | Ca(OH)₂) | | | | |
| | | (/total | (/total | Volume (L) of | (Min) | | Theoretical |
| | | weight of | suspension | the suspension | carbonation | Mass (kg) of | mass (kg) of |
| Test n^{o} | Polymer | Ca(OH)₂) | weight) | of Ca(OH)₂ | time | Ca(OH)₂ | PCC produced |
| 1 | — | — | 13.2 | 1,750 | 65 | 245 | 331 |
| 2 | PAA | 0.100 | 13.0 | 1,750 | 74 | 242 | 327 |
| 3 | P | 0.075 | 13.2 | 1,750 | 54 | 245 | 331 |
| 4 | — | — | 12.8 | 1,250 | 65 | 170 | 230 |
| 5 | P | 0.075 | 13.3 | 1,250 | 59 | 176 | 238 |
| 6 | P | 0.075 | 12.8 | 1,250 | 54 | 170 | 230 |
| 7 | P | 0.150 | 13.2 | 1,250 | 62 | 175 | 236 |
| 8 | P | 0.200 | 12.9 | 1,250 | 63 | 171 | 231 |
| 9 | — | — | 13.5 | 1,250 | 66 | 179 | 242 |
| 10 | P | 0.100 | 13.6 | 1,250 | 65 | 180 | 243 |
| 11 | PEG | 0.100 | 13.1 | 1,250 | 64 | 174 | 235 |

| | Volume | | | | | | |
|---|---|---|---|---|---|---|---|
| | (L) of | | | | | | |
| | dilution | | Mass (kg) of | Mass of PCC (kg)/ | | | |
| | water | μ100 | the suspension | ((min) carbonation time * | Polymorph | | BET SSA |
| Test n^{o} | added | (mPa · s) | of PCC | suspension PCC mass (kg)) | of PCC | d50 (μm) | (m²/g) |
| 1 | — | 23 | 1,994 | 0.15 | S-PCC | 2.36 | 4.1 |
| 2 | — | 18 | 2,070 | 0.13 | S-PCC | 2.32 | 4.5 |
| 3 | — | 15 | 2,122 | 0.17 | S-PCC | 2.25 | 5.8 |
| 4 | 350 | 340 | 1,853 | 0.11 | A-PCC | 1.48 | 10.3 |
| 5 | 350 | 260 | 1,711 | 0.14 | A-PCC | 1.80 | 8.5 |
| 6 | 100 | 200 | 1,584 | 0.16 | A-PCC | 1.80 | 9.4 |
| 7 | — | 299 | 1,425 | 0.16 | A-PCC | 1.91 | 8.9 |
| 8 | — | 255 | 1,384 | 0.16 | A-PCC | 1.98 | 8.6 |
| 9 | 450 | 220 | 1,920 | 0.11 | A-PCC | 1.51 | 9.3 |
| 10 | 50 | 215 | 1,492 | 0.15 | A-PCC | 1.95 | 8.4 |
| 11 | 150 | 228 | 1,656 | 0.13 | A-PCC | 1.98 | 9.1 |

In table 1 S-PCC indicates the presence of PCC of calcite of scalenohedron shape, while A-PCC makes reference to an aragonite structure.

The results of this table clearly show that only the polymer of the invention enables the carbonation time to be reduced very markedly, thus enabling the yield of this method to be increased, whilst preserving the structure of the manufactured PCC, and also its granulometric characteristics.

1. A method of manufacturing a precipitated mineral material, the method comprising:
contacting a precursor to the precipitated mineral material with at least one copolymer which comprises, expressed as a molar percentage of each monomer of the copolymer:
(a) 1% to 90% of at least one non-ionic monomer of formula (I): 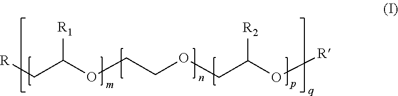
where wherein:
m, n, p and q are integers and m, n, and p are less than 150 and at least one m, n, p, and q is greater than 0,
R has at least one polymerizable unsaturated group,
R₁ and R₂ are identical or different and represent a hydrogen atom or an alkyl group having 1 to 4 carbon atoms,
R′ represents hydrogen or a hydrocarbon radical with 1 to 40 carbon atoms; and
(b) 10% to 99% of at least one vinylic monomer other than the at least one monomer of formula (I),
wherein a sum of molar percentages of monomers (a) and (b) is equal to 100%.

2. The method of claim 1, wherein the precipitated mineral material is a precipitated calcium carbonate.

3. The method of claim 1, wherein the at least one vinylic monomer (b) is selected from the group consisting of acrylic acid, methacrylic acid, acrylamide, methacrylamide, and a cationic monomer.

4. The method of claim 3, wherein a cationic monomer is present and is selected from the group consisting of a (meth)acrylic ester of a cationic monomer.

5. The method of claim 1, wherein the at least one polymerizable group of R is selected from the group consisting of a vinylic group, an acrylic ester, a methacrylic ester, a maleic ester group, an unsaturated urethane, or an optionally substituted allylic ester, an optionally substituted vinylic ether, an ethylenically unsaturated amide, and an ethylenically unsaturated imide.

6. The method of claim 1, wherein the at least one copolymer is obtained in acidic form and optionally distilled, and is partially or totally neutralized by at least one neutralization agent having a monovalent or polyvalent cation, wherein the at least one neutralization agent is selected from the group consisting of ammonia, calcium hydroxide, calcium oxide, sodium hydroxide, sodium oxide, magnesium hydroxide, magnesium oxide, potassium hydroxide, potassium oxide, lithium hydroxide, lithium oxide, an aliphatic secondary amine, a cyclic, secondary amine, an aliphatic, cyclic secondary amine, an aliphatic tertiary amine, a cyclic tertiary amine, and an aliphatic, cyclic tertiary amine or tertiary amines.

7. The method of claim 1, wherein the copolymer is obtained by
radical polymerization in solution, in a direct or reverse emulsion, in suspension or precipitation in at least one solvent, in the presence of at least one catalytic system and/or chain transfer agent, or
controlled radical polymerization.

8. The method of claim 1, wherein the copolymer is totally or partially neutralized and, before or after total or partial neutralization, treated and separated into several phases, by a static or dynamic method, by at least one polar solvent.

9. The method of claim 2, wherein the contacting comprises:
slaking a quicklime at least once, to give a slaked quicklime; and
carbonating the slaked quicklime at least once.

10. The method of claim 9:
wherein the slaking and carbonating comprise:
(A) slaking the quicklime in two phases by:
(a1) partially slaking of the quicklime by blending it with an aqueous solution b1) to obtain a partially hydrated lime; followed by
(a2) completely slaking by adding to the partially hydrated lime an aqueous solution b2) to obtain a suspension of slaked lime;
or
(A′) slaking the quicklime in one phase by:
blending the quicklime with an aqueous solution b3) to obtain the suspension of slaked lime;
(B) optionally, grinding the suspension of slaked lime from (A) or (A′); and
(C) carbonating the suspension of slaked lime from (A) or (A′) or (B) by introducing CO₂ into the suspension of slaked lime;
wherein the polymer is introduced:
during (A) in the aqueous solution b1) and/or b2);
or during (A′) in the aqueous solution b3),
and/or during (B) in the reactive medium.

11. The method of claim 2, wherein the copolymer is employed at a rate of 0.01 to 1% by dry weight, compared to a dry weight of slaked lime.

12. The method of claim 2, wherein the copolymer reduces carbonation time of the precipitated calcium carbonate.

13. The method of claim 4, wherein the cationic monomer is present and is selected from the group consisting of a [2-(methacryloyloxy)ethyl]trimethyl ammonium chloride, [2-(methacryloyloxy)ethyl]trimethyl ammonium sulphate, [2-(acryloyloxy)ethyl]trimethyl ammonium chloride, [2-(acryloyloxy)ethyl]trimethyl ammonium sulphate, [3-(acrylamido)propyl]trimethyl ammonium chloride, [3-(acrylamido)propyl]trimethyl ammonium sulphate, dimethyl diallyl ammonium chloride, dimethyl diallyl ammonium sulphate, [3-(methacrylamido)propyl]trimethyl ammonium chloride, and [3-(methacrylamido)propyl]trimethyl ammonium sulphate.

14. The method of claim 1, wherein the at least one polymerizable group of R is selected from the group consisting of an acrylurethane, a methacrylurethane, α-α′ dimethyl-isopropenyl-benzylurethane, an allylurethane, and a methacrylic ester.

15. The method of claim 6, wherein the at least one neutralization agent is selected from the group consisting of stearylamine, an ethanolamine, monoethylamine, diethylamine, cyclohexylamine, methylcyclohexylamine, amino methyl propanol, morpholine, and sodium hydroxide.

16. The method of claim 1, wherein the copolymer is obtained by nitroxide mediated polymerization (NMP), cobaloxime mediated polymerization, atom transfer radical polymerization (ATRP), or controlled radical polymerisation by at least one sulphurated derivative selected from the group consisting of a carbamate, a dithioester, trithiocarbonate, and a xanthate.

17. The method of claim 8, wherein the at least one polar solvent is selected from the group consisting of water, methanol, ethanol, a propanol, isopropanol, a butanol, acetone, and tetrahydrofuran.

18. The method of claim 1, comprising 50% to 98% of the at least one vinylic monomer (b) other than the at least one monomer of formula (I), wherein the sum of molar percentages of monomers (a) and (b) is equal to 100%.

19. The method of claim 1, comprising 80% to 97% of the at least one vinylic monomer (b) other than the at least one monomer of formula (I), wherein the sum of molar percentages of monomers (a) and (b) is equal to 100%.

20. The method of claim 1, comprising 85% to 95% of the at least one vinylic monomer (b) other than the at least one monomer of formula (I), wherein the sum of molar percentages of monomers (a) and (b) is equal to 100%.
